(19) United States
(12) Patent Application Publication
(10) Pub. No.: US 2008/0064766 A1
(43) Pub. Date: Mar. 13, 2008

(54) Apparatus for Enhancing Solubility

(76) Inventors: James Edward Delves, Bristol (GB); David John Parkinson, North Somerset (GB)

Correspondence Address: CAMERON INTERNATIONAL CORPORATION, P.O. BOX 1212, HOUSTON, TX, 77251-1212, US

(21) Appl. No.: 10/573,716

(22) PCT Filed: Sep. 28, 2004
(86) PCT No.: PCT/GB04/04145

§ 371 Date: Apr. 16, 2007

(30) Foreign Application Priority Data
Sep. 29, 2003 (GB) 0322754.3

(51) Int. Cl. B01F 3/12

(52) U.S. Cl. 516/31

(57) ABSTRACT

Apparatus for enhancing solubility of a solute in a solvent, the apparatus comprising a solvent and/or solute inlet 104 having a fluidising unit which creates a vortex such that a fluids interfacial/boundary layer exists within the vortex where enhanced mass transfer, or dissolution of solute into the solvent takes place.

This invention relates to an apparatus for enhancing the solubility of a solute in a solvent.

### BACKGROUND TO INVENTION

Manufacture of products in, for example, the food, drinks, chemicals, pharmaceuticals, petroleum refining or metal recovery industries often requires the mixing of solids in a liquid. This mixing normally relies on mechanical stirring devices, heat and in some cases pressure in order to dissolve the solids or fractions of the solids into a fluid state. This is normally done as a batch process and can be energy intensive due to the length of time required for the solids to dissolve in the liquids phase (the retention time), the temperatures involved and the need in many cases for mechanical mixing devices to keep the solids in suspension and expose as much surface area of the solids to be dissolved to the solids/liquid interface as possible. There may also be a need to mix dissimilar liquids or fluids and to process materials during transportation within a pipeline.

In conventional processes currently in operation, maintenance is a significant factor due to the abrasive nature of solids coming into contact with mechanical moving parts such as mixers, bearings and shaft seals.

It is known that the solubility and dispersion properties of water can be changed rapidly, even with minor changes in the water surface tension, surface areas in contact, temperatures and pressures. Water molecules are held together by their magnetic dipole attractions in a static and strong binding force. The internal binding forces existing in the water in a liquid form at atmospheric pressure are greater than those in its vapour form and are influenced by:

(1) Chemically active solutions, detergents and surfactants such as tensides.

(2) Physical changes: Temperature, pressure and electric or magnetic energy.

In the precious metal recovery industries the leaching and oxidizing processes require the pH of the solvents to be either acidic to dissolve the base metals or alkaline to precipitate the metals out of solution and recover the metal element or rare earth elements, together with high temperatures and pressure to increase the recovery efficiencies and reduce the processing time. The solvents can be extremely corrosive, which leads to corrosion/erosion of construction materials, especially those with moving parts.

In order to better describe the processes involved in this invention the following terms will be used:

(1) Solution—Is a homogeneous dispersion of two or more kinds of molecular or ionic substances.

(2) Solutions—Can be comprised of various combinations of the three states of matter not just liquids, water or aqueous solutions.

(3) Solvent—That component of a solution present in the greatest quantity.

(4) Solute—The other components which are dissolved in the greatest quantity.

(5) Solubility—The quantity of a solute that will dissolve in a specified quantity of solvent to produce a saturated solution.

(6) Saturated—A condition which exists when no more of a molecular or ionic species will dissolve in a liquid solution.

(7) Unsaturated—A condition which exists when more of a molecular or ionic species could be dissolved in a solution.

(8) Super-Saturated—A condition which exists when a solvent holds more of a solute in a solution than is normally possible at a given temperature. Such solutions are said to be Quasi-stable, normally achieved by elevating the-temperature of the solvent.

(9) Endothermic—Process requires heat to be supplied to the system from the surroundings.

(10) Surface energy—Solvent filling the space between particles is shielding local surface charges and can therefore reduce the attraction forces.

(11) Oxidation—Reduction reaction: reaction in which oxidation numbers change as electrons are lost by one atom and gained by another.

(12) Oxidising Agent—The substance in an Oxidation-reduction reaction that gains electrons and whose oxidation number is reduced.

(13) Cold Boiling—Water surface tension reduces and water changes to a gaseous state at temperature below 100 degrees C.

(14) Magnetised Water—When water moves or passes through a magnetic field the Hydrogen ions and dissolved minerals in the water will become charged, this charge also causes temporary separation of the minerals from the molecular water clusters. Magnetism causes the Hydrogen-Oxygen bond angle within the water molecule to reduce from 104 to 103 degrees, this in turn causes the water molecule to cluster together in groups of 6-7 rather than 10-12. Credible laboratory studies have shown increased solution precipitations, crystal size and morphology changes and enhanced and retarded coagulation lasting hours or even days.

It is known that an increase in pressure on its own will not necessarily increase the solubility of solids in liquids. It is also known that an increase in temperature with or without an increase in pressure can in certain instances increase solubility. It has also been identified that the rate of dissolution and saturation of a given solid in a given liquid or fluid is strongly affected by the motion and collision between solute and solvent. Increasing the surface area of the solid sample exposed to the solute also increases the rate of dissolution or mass transfer.

Considering potential environmental benefits, the process could be used to rapidly dissolve high volumes of salt into a saturated saline solution and to disperse the same at known concentrations. This could have a substantial impact on the Ocean Thermohaline Circulation (OTC), the Earth's natural “heat pump”. It is known that deep water circulation is created by heavy or salt water sinking in the North Atlantic regions where is can sink to some 6000 metres and take up to 2000 years to circulate through the Pacific and back up to the Artic. The warm waters from the south flow north in this Atlantic conveyor belt to replace the heavy sinking salty waters. There is a considerable amount of evidence accumulating worldwide that the effects of global warming has very strong potential to assist in the stopping of the OTC. This would have catastrophic effects on Europe and North America, creating substantial decreases in temperature and potentially destroying the ability to grow crops. Temperatures in the UK and continental Europe are elevated by the Gulf Stream, a warm Atlantic Ocean current that carries as much water as the Amazon River. Down-welling of heavy water is one process driving the Gulf Stream. Surprisingly this rapid sinking occurs principally in two quite small areas of the North Atlantic, one near Labrador and one in the Greenland Sea, where the warm waters are chilled by icy winds from nearby glaciers. Collective processes push dense, salty water towards the ocean depths and other Atlantic areas, down-welling is governed by the salt (haline) content and the heat content of the waters in these areas; hence it is called the Thermohaline circulation (THC). Should either of the two collective pumps weaken or shut off, average temperatures in the UK and continental Europe could plummet and no current models can accurately determine whether this would happen over a short or drastically quick time. There is considerable detail available from ice cores of this happening in the past. Man-made global warming and excessive CO2 in the atmosphere has clearly indicated several areas of weather change, such at El Nino becoming more extreme each year, excessive rainfall and flooding and increasing large numbers of icebergs each year being counted by the North American authorities.

Governments worldwide are now turning their attention to how best to stop global warming by controlling release of greenhouse gases to the atmosphere, as it is fairly well understood today that it is this global warming that is causing icebergs to melt. More fresh river water flowing into the Northern Atlantic itself lowers the salinity of the North Atlantic waters directly, but the process requires these waters to be dense and to sink, to keep the Atlantic conveyor moving. Any changes brought about in the coming years will have a very slow effect on the overall weather patterns. One of these measurements being undertaken by oceanographic scientists is the lowering of salinity in the areas where the salt water sinks. Although it may not be possible in the short term to undo the effects of global warming it may be possible to utilise the World's vast resource of salt in areas such as Bonneville Salt Flats in the USA and other desert regions and inject the same into the areas of the North Atlantic where the salinity is dropping. This will have the effect of retarding the slowdown in the Atlantic conveyor, i.e. maintaining the Gulf Stream flow north.

One might imagine that vast volumes of salt would be required to achieve this goal, but as it is only two small areas in the North Atlantic where this crucial sinking of heavy salt water takes place, it is likely that we could treat the effect rather than the cause. In other words, it would be possible to dose a concentrated salt solution in these areas at the required depth to enhance the sink rate whilst global warming is addressed simultaneously by other methods and processes. The present invention could be used on a floating unit such as a FPSO in the oil industry, with a process plant on top capable of rapidly dissolving salt and delivering it to the areas required in a liquid state such that enhancement of the sinking process takes place immediately where required. The solvent in this case will be the low salinity salt water in the area.

### STATEMENT OF THE INVENTION

According to a first aspect of the present invention, there is provided apparatus for enhancing solubility of a solute in a solvent, the apparatus comprising a solvent and/or solute inlet having a fluidising unit which creates a vortex in the solvent and/or solute.

Fragmentation or attrition of particles occurs within the vortex's localised area of fluid flow where enhanced mass transfer, or dissolution of solute into the solvent takes place due to the increased surface area available, or in some cases the porosity of the particles, allowing better wetting under these prevailing conditions.

Preferably, the apparatus further comprises a fluid outlet. Preferably, the fluidising outlet is displaced from the fluidising unit.

According to a second aspect of the present invention there is provided a method of enhancing solubility of a solute in a solvent, the method comprising passing the solvent and/or solute through a fluidising unit which creates a vortex in the solvent and/or solute.

Preferably, the solute is leached from a carrier ore (rapid pressurised leaching).

Preferably, means are provided to achieve at least two stages of leaching, targeted at different solutes to be dissolved in different solvents.

Preferably, the solute is salt and the solvent is water, to make a saturated salt solution. The salt solution may, for example, be used for dosing or as a carrier fluid.

Preferably, the solute is an edible or potable solute for use in a solution for the food and brewing industry.

Preferably, the apparatus is used for accelerated malting of materials for the brewing industry.

Preferably, the apparatus is used for accelerated dissolving of sugars, glucoses or other materials such as cola nuts for use in the soft drinks industry.

Preferably, the apparatus is used for pressurised rapid wetting of seeds prior to sowing, to accelerate germination and growth.

Preferably, the apparatus is used for pressurised treatment of seeds with fungicides, nutrients, fertilisers and/or pesticides prior to sowing.

The fluidising unit may be operated at below or above atmospheric pressure, and/or at elevated temperatures. The fluidising unit can be any type of swirling unit that is designed to create any type of forced or free vortex in a fluid phase.

Due to the unique hydrotransportation features of the fluidising unit described below, but generally due to its ability to move solid/liquid slurries at elevated pressures and low velocities without any moving parts has created the possibility of utilising such systems for continuous processing of material rather than just transportation. Therefore, preferably the fluidising unit is used to transport material as well as process it, on a continuous, rather than batchwise basis, hence taking advantage of any potential retention time in transportation pipelines for example. Following considerable experimental test work, utilising a fluidising system as described, substantial benefits have been identified whilst transporting and treating a range of substances. Particular benefits have been identified for the following substances.

1. Oil wetted solids such as tar sands.

2. Activated carbon—partial cleaning without damage to the material.

3. Dissolution of solids such as salt into liquids.

4. Rapid leaching of metals from solids in solvent solutions, sometimes enhanced by electromagnetic forces or ultrasound-induced cavitation.

5. Pressure wetting of barley seed during transportation for a malting process. This has also led to accelerated germination of seeds with the potential for a pressure spray seeding system for use in agriculture.

6. Partial regeneration of ion exchange resins and catalysts.

In the case of the barley seeds discussed in 5 above the seed became wetted substantially faster which allowed the water at an ambient temperature of 16 degrees Centigrade to permeate the seeds' husks to allow the seeds to germinate in a time of between 6-8 hours as against 36 hours as seen in conventional brewing methods.

In the case of salts as discussed in 3 above the solvent (water) reached saturation level in approximately 30 seconds as against the normal recognised time of 1500 seconds, again carried out at an ambient temperature of 16 degrees Centigrade. The use of Computational Fluid Dynamics (CFD) has allowed a better understanding of why this acceleration in mass transfer happens.

The present invention is particularly applicable to the sub and supercritical water oxidation process (SCWO). SCWO technology involves operations above the critical temperature and pressure of pure water (Tc=374 C, pc=221 bar), where the properties of water are significantly altered. At supercritical conditions, organic compounds that are insoluble at ordinary temperatures usually become more soluble, whereas salts that are soluble at ordinary temperatures become much less soluble. Thus, organic materials in supercritical water can rapidly be oxidized using air or oxygen to produce fully oxidised species, with the salts precipitating out.

In the SCWO process, the aqueous input stream is pressurised, heated, and mixed with oxidant (e.g, air or oxygen), then pumped through a flow reactor such as is described in GB 0225802.8 (AtmoTrans) or GB 0212728 (HydroTrans) at the supercritical conditions designed to provide the required residence time. Heat produced by the oxidation can be recovered (or must be removed) based on the heat content of the waste stream. If the input stream has inadequate fuel value to heat the reactor, make-up fuel can be added. Downstream of the reactor, the pressure in the system is “let down” either before or after cooling. Solids produced from the oxidation reactions can be recovered prior to or following pressure let-down. Cooling prior to pressure let-down often results in the redissolution of salts, which can be removed later via evaporation. These salts can also be removed prior to pressure let down using a high pressure filter, for example a radial media filter as described in GB 0308219.4 (DynaSep).

### BRIEF DESCRIPTION OF THE DRAWINGS

For a better understanding of the present invention, and to show more clearly how it may be carried into effect, reference will now be made, by way of example, to the accompanying drawings, in which:—

FIG. 1 is a longitudinal cross-section through a fluidising apparatus;

FIG. 2 is a cross-section on line AA in FIG. 1;

FIG. 3 is a Computational Fluid Dynamics (CFD) image of the pressure profile of the fluidising apparatus of FIG. 1;

FIG. 4 is a CFD image of the inverted vortex flow from fluidising apparatus of FIG. 1;

FIG. 5 is a schematic diagram of a typical precious metal recovery plant; and

FIG. 6 is a schematic diagram of a mixing apparatus using a magnetic unit.

### DETAILED DESCRIPTION OF A PREFERRED EMBODIMENT

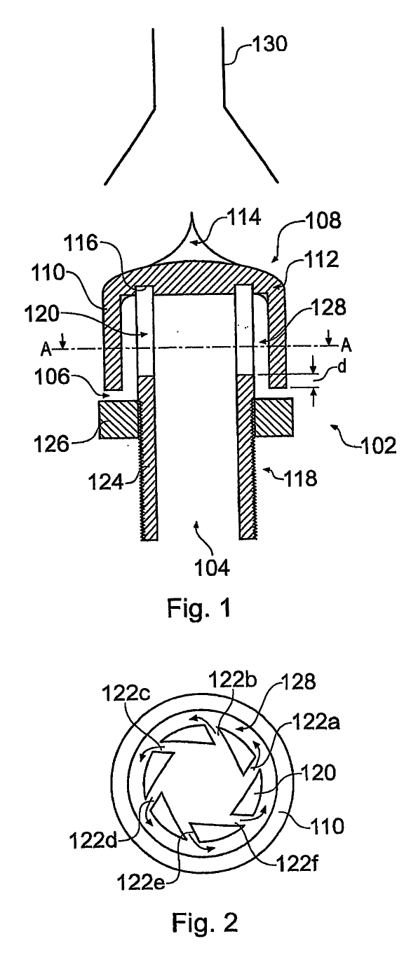

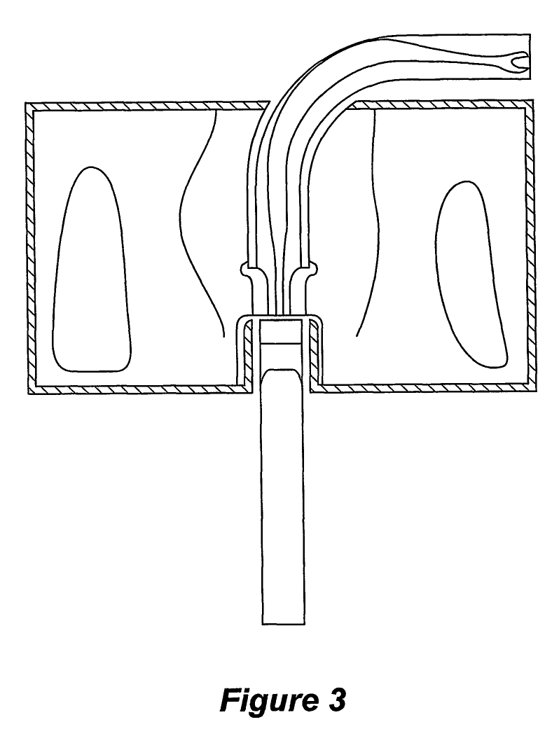

FIGS. 1 and 2 illustrate a fluidising unit comprising a flow chamber 102 having a fluid inlet 104 and a fluid outlet 106. The flow chamber 102 comprises a housing in the form of a cap 108 having a side wall 110 and a top 112 which in the region 114 is generally in the shape of a cone with a concave side wall. The underside of the top 112 is provided with an annular recess 116 in which is located a cylindrical flow guide 118. As best shown in FIG. (2), the upper portion 120 of the flow guide 118 is provided with a series of tangential slots 122a to 122f. The lower portion 124 of the flow guide 118 has an external thread which cooperates with an internal thread formed in an annular flange 126.

A fluid outlet 106 is defined between the side wall 110 of the cap 108 and the flange 126 and an annular flow passage 128 is defined between the side wall 110 of the cap 108 and the upper portion 120 of the flow guide 118. The annular flow passage 128 is continuous with the fluid outlet 106, so that the fluid inlet 104 communicates with the fluid outlet 106 by means of the tangential slots 122a to 122f and the flow passage 128. Directly above the flow chamber 102 is located a discharge pipe 130.

In use of the “HydroTrans” fluidising unit illustrated in FIGS. 1 and 2, fluid under pressure enters the fluidising unit through the fluid inlet 104, passes down the flow guide 118 and exits the flow guide tangentially via the slots 122a to 122f (as the open end of the flow guide 118 is closed by the cap 108). The cap 108 also acts as a swirl enhancer and is positioned such that its side wall 110 forms one side of the said annular flow passage 128 around the tangential slots 122a to 122f. The cap 108 is longer than the slots 122a to 122f, such that it overlaps the slots by an amount ‘d’ and defines the fluid outlet 106 by which the concentrated swirling fluid exits the flow chamber 10 The profiled region 114 of the cap 108 is shaped in order to encourage a stable fluid regime above the flow chamber 102.

FIG. 3 shows the pressure profile of the HydroTrans fluidising unit, with a solvent feed pressure of 20 psig. The pressure profile is created by Computational Fluid Dynamics (CFD).

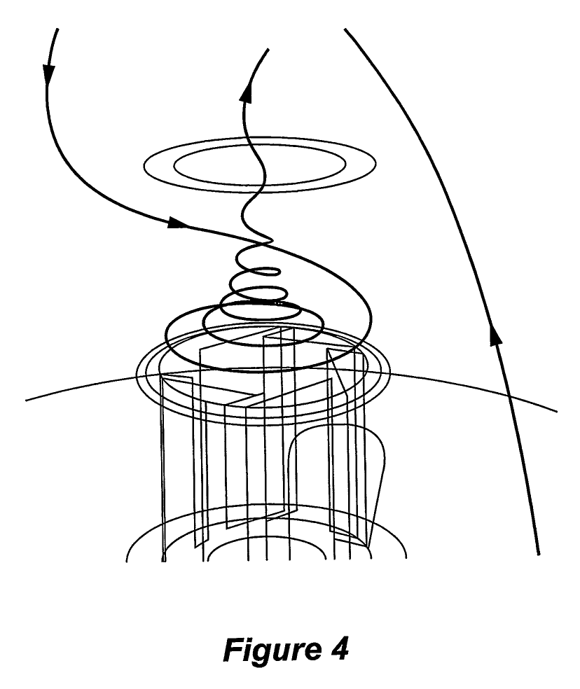

FIG. 4 shows that the swirling exiting fluid (solvent) from the HydroTrans head produces an inverted vortex at the entry to the discharge pipe, which is considered to be fairly stable under normal velocity flow conditions, resulting in enhanced mobilisation of solids surrounding the HydroTrans head. The vortex generally has a low pressure core or zone compared to that of the rotating liquid around it (see FIG. 3). This can create a boundary layer of liquid rotating around this core where the core's pressure may be close to the vapour pressure of the liquid (solvent) being used thus allowing the water at this point to become excited leading potentially to cold boiling. For example, water, whilst still below its natural boiling temperature, can behave as boiling water (water surface tension reduces, and may even affect the water's natural capilliary force) which may approach endothermic conditions at certain temperatures which could increase the solubility of the solute in question.

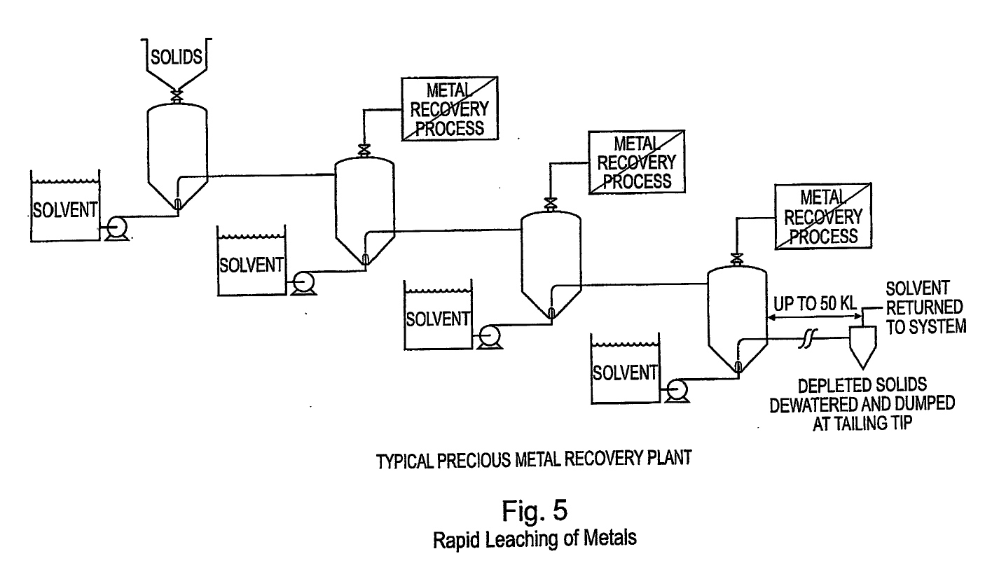

The dissolving, leaching (see FIG. 5) or oxidising process using the fluidising unit can be carried out below atmospheric pressure until it is discharged into an open tank or vessel. The dissolving, leaching or oxidising process in the fluidising unit can also be carried out in a pressurised environment, although the vortex zone of influence created by the fluidising unit will normally show evidence of a lower pressure zone to the surrounding liquid pressures. The vortex low pressure zone/core can only exist within the vortex itself and virtually instantaneously reverts back to the surrounding pressure when discharged from the pressure vessel. This rapid fluctuation in pressure zones can in some instances assist in keeping the solutions in a saturated or super-saturated state.

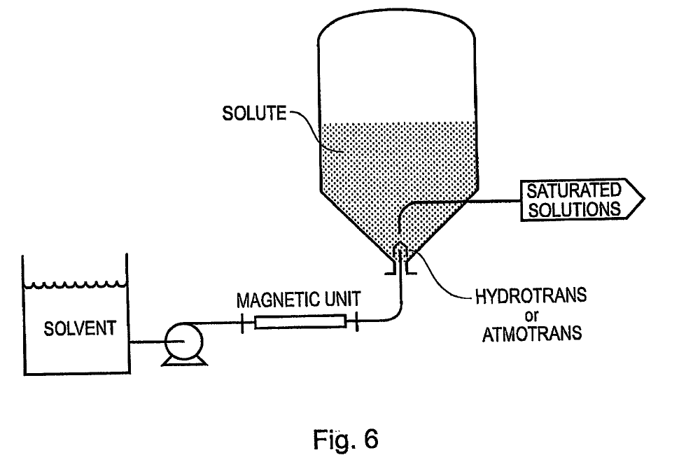

The process may be further improved by passing the feed fluid and/or slurry/solution discharge through a magnetic field to magnetise for example the feed water (solution), see (see FIG. 6) prior to the formation of the vortex to enhance the cold boiling effect. The process may be further enhanced due to the particle interaction and attrition created within the aforementioned reasonably stable vortex. The ability of the fluidising unit to control solids (solute) discharge concentration also effects and helps to control the dissolving rate of the solids (solute).

The process can be described as a high throughput low size reactor within the confines of a large vessel which can subject each particle in the zone of influence of the vortex to the reaction described above prior to discharging the solids and saturated solution from the vessel. This maybe due to the mass transfer happening within the vortex and the fluidising unit creating the vortex, which is also in close proximity to the discharge pipe exiting the vessel, where the greatest Delta P will be evident.

The process described above can be used in the metals recovery industry (see FIG. 5) to achieve rapid leaching, and has the benefit of increasing recovery levels of metals whilst reducing solvent and chemical demands. This increases the efficiency and economic viability, whilst reducing volumes of waste streams to the environment. For example, if the process is used for leaching copper with an acid from ore in a pressurised system as opposed to a heap stack process, the environmental benefit is substantial.

The process allows the use of continuous metal recovery systems which can have several treatment stages using different solvents, acidic or alkaline; to seek out and recover particular metals in the recovery process as may be required, see (FIG. 5).

1. Apparatus for enhancing solubility of a solute in a solvent, the apparatus comprising a solvent and/or solute inlet having a fluidising unit which creates a vortex in the solvent and/or solute.

2. Apparatus as claimed in claim 1, in which a fluid interfacial or boundary layer exists within the vortex where enhanced mass transfer, or dissolution of solute into the solvent takes place.

3. Apparatus as claimed in claim 1, in which the solute is leached from a carrier ore.

4. Apparatus as claimed in claim 3, in which means are provided to achieve at least two stages of leaching, targeted at different solutes to be dissolved in different solvents.

5. Apparatus as claimed in claim 1, in which the solute is salt and the solvent is water.

6. Apparatus as claimed in claim 1, in which the solute is an edible or potable solute for use in a solution for the food and brewing industry.

7. Apparatus as claimed in claim 1, for use in accelerated malting of materials for the brewing industry.

8. Apparatus as claimed in claim 1, for accelerated dissolving of materials selected from the group consisting of sugars, glucoses and cola nuts for use in the soft drinks industry.

9. Apparatus as claimed in claim 1, for pressurised rapid wetting of seeds prior to sowing, to accelerate germination and growth.

10. Apparatus as claimed in claim 1, for pressurised treatment of seeds with fungicides, nutrients, fertilizers and/or pesticides prior to sowing.

11. Apparatus as claimed in claim 1, in which the fluidising unit operates on a continuous flow of solvent and/or solute.

12. Apparatus as claimed in claim 1 further comprising a flow chamber having a fluid inlet and a fluid outlet and at least one tangential slot.

13. Apparatus for enhancing solubility of a solute in a solvent, the apparatus comprising a solvent and/or solute inlet having a fluidising unit which creates a vortex in the solvent and/or solute, a flow chamber having a fluid inlet and a fluid outlet and at least one tangential slot, where the fluid outlet is defined at least partially by a cap.

14. A method for enhancing solubility of a solute in a solvent, the method comprising:
providing an apparatus having a solvent and/or solute inlet and a fluidising unit; and
creating a vortex in the solvent and/or solute.

15. The method of claim 14, further providing a fluid interfacial or boundary layer within the vortex where enhanced mass transfer, or dissolution of solute into the solvent takes place.

16. The method of claim 14, further comprising leaching the solute from a carrier ore.

17. The method of claim 14, in which the solute is salt and the solvent is water.

18. The method of claim 14, in which the solute is an edible or potable solute for use in a solution for the food and brewing industry.

19. The method of claim 14, further comprising pressurised rapid wetting of seeds prior to sowing, to acceleration germination and growth.

20. The method of claim 14, in which the fluidising unit operates on a continuous flow of solvent and/or solute.
